(19) United States
(12) Patent Application Publication
(10) Pub. No.: US 2004/0099974 A1
(43) Pub. Date: May 27, 2004

(54) Method and apparatus for patterning an optical element

(75) Inventor: Pang-Lun Yang, Taichung Hsien (TW)

Correspondence Address: Ladas & Parry, 26 West 61st Street, New York, NY, 10023, US

(73) Assignee: BENQ CORPORATION

(21) Appl. No.: 10/716,068

(22) Filed: Nov. 18, 2003

(30) Foreign Application Priority Data
Nov. 22, 2002 (TW) 91134116

(51) Int. Cl. B29D 11/00

(52) U.S. Cl. 264/2.7; 425/117; 425/808

(57) ABSTRACT

A method for patterning an optical element is disclosed. The method includes providing a lower mold, positioning the optical element on a carrier face of the lower mold, then providing and positioning an upper mold above the optical element. A plurality of protrusions are mounted on a pressing face of the upper mold. The method further includes a step of driving the upper mold with a driving device to thermally press the optical element so that the protrusions of the upper mold will press and insert into the optical element. Finally, separating the upper mold from the optical element for forming a plurality of patterns corresponding to the protrusions on the optical element.

### FIELD OF THE INVENTION

The present invention relates to a method for patterning an optical element, more particularly, to a method for patterning the optical element by thermal pressing.

### BACKGROUND OF THE INVENTION

With rapid advancement of the fabrication technology of a thin film transistor liquid crystal display (TFT-LCD), the LCD is largely applied in various electronic products such as a Personal Digital Assistant (PDA) device, a notebook computer, a digital camera, a video camera, and a mobile phone due to the fact it has advantages of smaller size, lighter weight, lower power consumption and low radiation. Moreover, the quality of the LCD is improved and the price thereof is continuously decreased since manufacturers aggressively invest in research & development and employ large-scale fabricating equipment. That promptly broadens the applied fields of the LCD.

Since the LCD is not a light-emitting display apparatus, it performs a display function with the aid of a back light module. Please refer to FIG. 1 illustrating a sectional view of the back light module 10. The back light module 10 comprises a light guiding plate 11, a reflective plate 12, a lamp 13, a plurality of optical thin films 14 and a frame 15. The light guiding plate 11 and these optical thin films 14 are made of acrylic materials by injection or extrusion. Patterns as diffusion dots 16 for scattering light are formed on the bottom surface of the light guiding plate 11 and the surface of the optical thin films 14 for improving the brightness and the viewing angle of the LCD. The reflective plate 12 is disposed beneath the light guiding plate 11 and can reflect the light coming out from the light guiding plate 11 to return the light to the light guiding plate 11 for increasing the utilization of light. The lamp 13 is mounted at one side of the light guiding plate 11 and transmits lights into the light guiding plate 11 via one end of the light guiding plate 11. The lamp 13 is generally composed by a cold cathode fluorescent lamp (CCFL). The frame 15 is mounted at the bottom and sides of the back light module 10 for protecting the back light module 10 and the elements therein.

U.S. patent application Ser. Nos. 09/766,774 and 09/766,914 disclose two inventions relating to methods and apparatuses for patterning a light guiding plate. In the disclosure, a plurality of pins of a V-cutter are inserted into the surface of the light guiding plate. A driver is used to drive the V-cutter in motion relative to the light guiding plate, so that a plurality of V-shaped grooves are formed on the surface of the light guiding plate. The pattern density of the grooves on the surface of the light guiding plate is gradually increased from one end near the lamp to the other end far away from the lamp, so that the uniformity of the light dispersed from the light guiding plate is increased. However, the V-shaped grooves are formed by the cutter in the prior art, and it is inevitable to lead to errors in size of the V-shaped grooves because the pins of the cutter are worn out during the continuous scraping process. Moreover, the scraping forces of the pins applied to different positions of each V-shaped groove might be different and the depths at the different positions of each V-shaped groove would be different. That affects the quality of the back light module.

In view of the above, those skilled in this art endeavor to improve the fabrication of the optical elements so as to invent a method for patterning the optical elements, which forms patterns thereon in better quality and with a more rapid speed.

### SUMMARY OF THE INVENTION

The objective of the present invention is to provide a method for patterning an optical element in better quality and in a more efficient way.

The first step of the method in this invention is to provide a lower mold and an upper mold. The lower mold has a carrier face on which an optical element is carried. The optical element can be a light guiding plate, a diffusing sheet or other optical films. Moreover, a plurality of cooling pipes are mounted in the lower mold. Later, the optical element is fixed on the carrier face of the lower mold with a holding component. The upper mold is subsequently positioned above the optical element. The upper mold has a pressing face with plurality of protrusions. Then, the upper mold is driven by a driving device to thermally press the optical element. Thus, the protrusions of the upper mold can be pressed and inserted into the optical element. At the same time, the optical element can be cooled by the cooling pipes in the lower mold during the thermal pressing process. Finally, the upper mold is separated from the optical element, and thus patterns corresponding to the protrusions are formed on the surface of the optical element.

The thermal pressing process in this invention includes the following steps. The upper mold is firstly heated by a heater mounted in the upper mold to a melting temperature of the optical element. Then, the protrusions of the upper mold are used to thermally press the optical element so as to form a plurality of patterns corresponding to the shape of the protrusions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a sectional view of a back light module in the prior art;

FIG. 2 is a schematic sectional diagram illustrating one embodiment of the apparatus for patterning an optical element in accordance with this invention; and

FIG. 3 is a flow chart of the method for patterning the optical element in accordance with this invention.

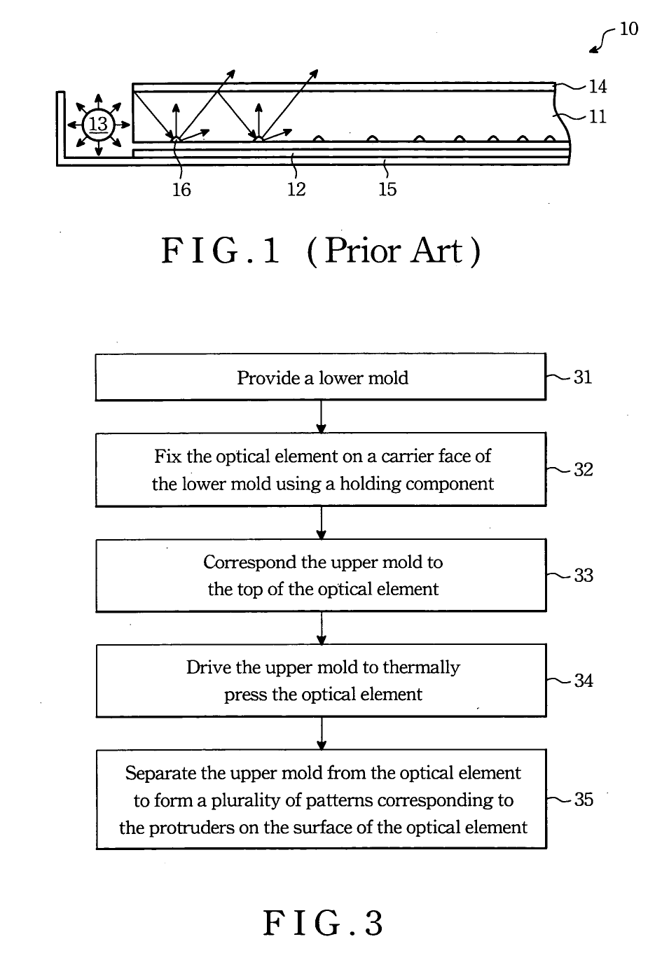

### DETAILED DESCRIPTION OF THE PREFERRED EMBODIMENT

The present invention relates to a method for patterning an optical element by means of thermal pressing. The best mode is described below in detail.

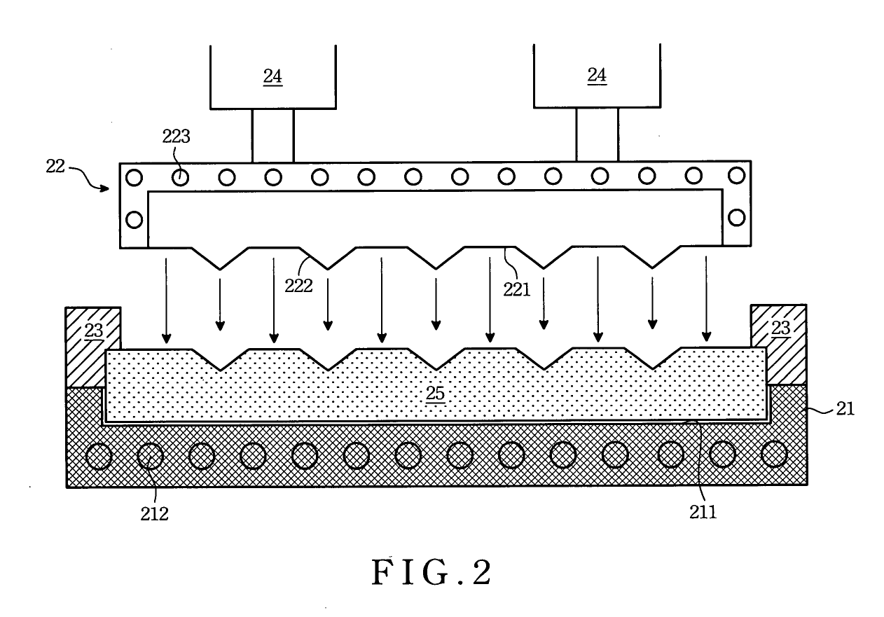

Please refer to FIG. 2, which is a schematic sectional diagram illustrating one embodiment of the apparatus for patterning an optical element in this invention. The apparatus includes a lower mold 21, an upper mold 22, a holding component 23 and a driving device 24. The lower mold 21 has a carrier face 211 on which the optical element 25 is positioned and fixed by the holding component 23. Moreover, a plurality of cooling pipes 212 are mounted in the lower mold 21. The upper mold 22 has a pressing face 221 corresponded to the carrier face 211 of the lower mold 21. The upper mold further has a plurality of protrusions 222 arranged by a predetermined pattern. When the protrusion 222 is in a V shape, V-shaped grooves can be formed on the optical element 25. The protrusion 222 can be in other shapes such as a U shape according to different optical elements. Furthermore, a heater 223 is further disposed in the upper mold 22. The driving device 24 is mounted on the top of the upper mold 22 to drive the upper mold 22 toward the lower mold 21 during a thermal pressing process.

Please refer to FIG. 3, which is a flow chart of the method for patterning the optical element by a thermal pressing process in accordance with this invention. The method includes steps of (a) firstly providing the lower mold (step 31); (b) positioning the optical element on the carrier face of the lower mold (step 32); and (c) positioning the upper mold above the optical element (step 33). In the step 32, the optical element is fixed by the holding component. The optical element can be a light guiding plate, a diffusing sheet or other optical films. In addition, there are protrusions formed on the pressing face of the upper mold. The method further includes a step of (d) driving the upper mold with the driving device to thermally press the optical element so that the protrusions of the upper mold can be inserted into the optical element (step 34). In this step, the optical element can be cooled by the cooling pipes during the deformation of the optical element when heated. The finally step is to separate the upper mold and the optical element, and patterns corresponding to the protrusions are formed on the optical element (step 35).

The upper mold and the lower mold of this invention are made of cupper alloy or other heat conductive materials. In the process of thermal pressing, the upper mold is heated by the heater to a melting temperature of the optical element and then thermally presses the optical element. A plurality of patterns corresponding to the protrusions are formed on the optical element because of heat and pressure. In addition, the cooling pipes in the lower mold not only can cool the optical element, but also prevent the optical element from curving or deforming during the thermal pressing process.

Therefore, comparing with the prior art, this invention has the following advantages:

1. The optical element can be patterned by only one thermal pressing process. But in the prior art, multiple scraping procedures are needed. Hence, the method of this invention is more efficient.

2. By using a thermal pressing process, the protrusions are less worn out in the present invention. In the prior art, patterns of the optical element are formed by scraping so that the pins are more liable to be worn out during scraping.

3. The quality of the patterns formed in this invention by a manner of thermal pressing is better.

4. The protrusions of the upper mold can be changed based on the size and material of the optical element as well as the desired patterns. Hence, it is unnecessary to change the whole upper mold for different optical elements, and the manufacturing cost is reduced.

5. During the thermal pressing process, the cooling pipes in the lower mold can be used to cool the optical element, thereby enhancing the process efficiency.

As is understood by a person skilled in the art, the foregoing preferred embodiment of the present invention is illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed:

1. A method for patterning an optical element, comprising steps of:
providing a lower mold with a carrier face;
positioning said optical element on said carrier face of said lower mold;
providing an upper mold above said optical element, said upper mold having a pressing face, and a plurality of protrusions with pre-determined patterns mounted on said pressing face;
thermally pressing down said upper mold so as to insert said protrusions into said optical element; and
separating said upper mold from said optical element for forming a plurality of patterns corresponding to said protrusions on said optical element.

2. The method of claim 1, further comprising a cooling step operated by a plurality of cooling pipes mounted in said lower mold during the thermal pressing step, and said cooling pipes being used to cool down said optical element in the thermal pressing step so as to prevent said optical element from bending.

3. The method of claim 1, wherein said optical element is positioned and fixed on said carrier face of said lower mold. by a holding component.

4. The method of claim 1, wherein said upper mold is operated at a thermal pressing temperature during the thermal pressing step, and the thermal pressing temperature is the melting temperature of said optical element.

5. The method of claim 1, wherein said upper mold is driven by a driving device during the thermal press step, and said driving device is mounted with said upper mold.

6. The method of claim 1, wherein said optical element is a light guiding plate.

7. The method of claim 1, wherein said optical element is made of acrylic materials.

8. The method of claim 1, wherein said optical element is a diffusing sheet.

9. The method of claim 1, wherein said upper mold is made of cupper alloy.

10. The method of claim 1, wherein said upper mold is heated by a heater during the thermal pressing step so that said protrusions are heated to thermally press said optical element.

11. The method of claim 1, wherein said protrusions are in a V shape and said patterns formed on said optical element are V-shaped grooves.

12. A apparatus for patterning an optical element with a thermal pressing process, comprising:
a lower mold with a carrier face for positioning said optical element thereon, and a plurality of cooling pipes being mounted in said lower mold;
a holding component disposed on said carrier face to fix said optical element;
an upper mold with a pressing face corresponded to said carrier face and a plurality of protrusions of predetermined patterns being mounted on said pressing face, and said upper mold having a heater mounted therein; and
a driving device connected to said upper mold to drive said upper mold during said thermal pressing process.

13. The apparatus of claim 12, wherein said plurality of cooling pipes is used to cool down said optical element during the thermal pressing process so as to prevent said optical element from bending.

14. The apparatus of claim 12, wherein said upper mold and said lower mold are made of cupper alloy.

15. The apparatus of claim 12, wherein said heater heats said upper mold to a predetermined temperature for said thermal pressing process.

16. The apparatus of claim 12, wherein said upper mold is operated under a thermal pressing temperature during said thermal pressing process, and said thermal pressing temperature of said upper mold is a melting temperature of said optical element.

17. The apparatus of claim 12, wherein said protrusions are in a V shape and said patterns formed on said optical element are V-shaped grooves.

18. The apparatus of claim 12, wherein said optical element is a light guiding plate.

19. The apparatus of claim 12, wherein said optical element is a diffusing sheet.

20. The apparatus of claim 12, wherein said optical element is made of acrylic materials.
